(19) United States
(12) Patent Application Publication
(10) Pub. No.: US 2012/0039076 A1
(43) Pub. Date: Feb. 16, 2012

(54) ENERGY-SAVING LIGHTING DEVICE WITH EVEN DISTRIBUTION OF LIGHT

(76) Inventor: Ping-Han CHUANG, New Taipei City (TW)

(21) Appl. No.: 13/274,312

(22) Filed: Oct. 15, 2011

Related U.S. Application Data
(63) Continuation-in-part of application No. 12/230,569, filed on Sep. 2, 2008, now abandoned.

(51) Int. Cl. F21V 7/06; F21V 7/08

(52) U.S. Cl. 362/297

(57) ABSTRACT

An energy-saving lighting device includes a lampshade body, a light-transmissive plate located on the bottom side of the lampshade body, a parabolic reflector and a nonlinear reflector having a light distribution curve mounted in the lampshade body, a light emitting device mounted in the lampshade body, and a cone reflector disposed in the lampshade body right below the light emitting device. When the light emitting device is electrically connected to emit light, light rays are evenly distributed in the illumination area without causing Gaussian distribution, thereby saving the energy and avoiding dazzling.

### CROSS-REFERENCE TO RELATED APPLICATION

The present invention is a continuation-in-part of U.S. patent application Ser. No. 12/230,569.

### BACKGROUND OF THE INVENTION

1. Field of the Invention

The present invention relates to a lampshade for lamp and more particularly, to an energy-saving lighting device, which is environmental friendly and energy saving and practical for home, factory and street applications and, which is designed subject to the principles of optical reflection, refraction and critical angles, minimizing light loss, assuring even distribution of light in the illumination area and, avoiding dazzling.

2. Description of the Related Art

Regular lighting fixtures include two types, one for indoor application and the other for outdoor application. FIG. 1A illustrates a conventional indoor lighting fixture, which comprises a light source 102, and an open type opaque lampshade 101 provided at the top side of the light source 102. The open type opaque lampshade 101 has a reflective inner surface 103. To avoid dazzling the eyes, the surface of the light source is usually frosted. Regular outdoor lighting fixtures are usually equipped with a full-closed lampshade (see FIG. 1B) in which the bottom light transmissive cover 104 is frosted to avoid dazzle. However, conventional lighting fixtures, either with an open type lampshade or a full-closed type lampshade, have the common drawbacks of big brightness loss and local concentration of light right below the light source.

Further, conventional lighting devices commonly use a reflector of simple geometric curve for reflecting light toward the desired illumination area. As the illuminance of the illuminated area is inversely proportional to the square of the distance of the light source, the illuminance of the surface illuminated by a conventional lighting device shows a Gaussian distribution, i.e., the illuminance in the area relatively closer to the light source is relatively higher and the illuminance in the area relatively farther from the light source is relatively lower. One drawback of the presence of Guassian distribution is the uneven illuminance in the illuminated area. Another drawback of presence of Guassian distribution is that the necessity of enhancing the intensity of the light source to achieve the minimum illuminance in the area far away from the light source results in unnecessary consumption electrical energy.

Contrast glare is where one part of the vision area is much brighter than another. It makes your eyes feel tired and fatigued easily, or may affect your visual health.

Since the ancient times, human beings have been accustomed to use sunlight for illumination. As the sun is far enough away from the earth, the illuminance is uniformly distributed. To eliminate dazzling when using conventional lighting devices, people may take the following measures:
1. Extend the distance between the light source and the illuminated area. However, because this measure causes waste of energy, it is not practical under the concept of energy saving and environmental protection.
2. Using a frosted glass at the light-emitting area or coating a fluorescent substance on the light-emitting area to diffuse the emitted light. However, this measure consumes much energy and cannot eliminate the problem of Gaussian distribution.
3. Setting a light shield plate at the front side of the light source to block the direct light. Using light shield means to progressively shield the light can achieve even illumination, however this measure consumes much power energy, about 3-10 times and more.

Uneven illumination of street lights may cause vehicle drivers to feel the space bright one moment and dark the next like the zebra stripes. A vehicle driver may get fatigued easily under this environment. Uneven illuminance for commercial illumination cannot present the color characteristics of the exhibited products, affecting the sale of the products. When working under an even illuminance environment, a worker may make a wrong judgment, affecting product quality. Therefore, it is necessary to design a lampshade for lighting device which facilitates even distribution of light.

### SUMMARY OF THE INVENTION

The present invention has been accomplished under the circumstances in view. It is therefore the main object of the present invention to provide an energy-saving lighting device with even distribution of light, which eliminates the drawbacks of the conventional designs.

To achieve this and other objects of the present invention, an energy-saving lighting device comprises a lampshade body having installed therein a lamp holder electrically connected to power supply means, a light emitting device installed in the lamp holder for emitting light, a parabolic reflector adapted having a through hole on a top side thereof for the passing of the light emitting device and adapted for converting a part of light rays emitted by the light emitting device into downwardly extending parallel light rays, a light transmissive plate mounted in an illumination side of the lampshade body, a cone reflector fixedly mounted on an inner side of the light-transmissive plate and having a vertex aimed at the center of the light emitting device and adapted for converting the downwardly extending parallel light rays into horizontally extending light rays, and a nonlinear reflector fixedly mounted in the lampshade body and abutted against the parabolic reflector and having a plurality of facets connected to one another at an inner side thereof and constituting a light distribution curve. The size and angle of each facet is calculated subject to the principle of optical reflection and expected contained angle between the incident light of the horizontally extending parallel light rays and the light reflected by the respective facet toward a predetermined illumination block.

The light emitted by the light emitting device partially directly projects onto the predetermined illumination block and partially reflected or refracted by the parabolic reflector, the cone reflector and the nonlinear reflector onto the predetermined illumination block. The predetermined illumination block to be illuminated is equally divided into multiple sub blocks, and the luminous flux of every sub block of the direct light emitted by light emitting device onto the respective sub block and the light emitted by the light emitting device and primarily refracted by the cone reflector onto the respective sub block are calculated. The light rays emitted by the light emitting devices and secondarily refracted by the parabolic reflector and the cone reflector toward the facets of the nonlinear reflector are reflected by the facets of the nonlinear reflector onto predetermined sub blocks of the predetermined illumination block to make even the luminous flux of every sub block, achieving even distribution of light in the predetermined illumination block.

To eliminate the problem of uneven distribution of light of the conventional designs that the area right below the light source is relatively brighter and the area relatively far away from the light source is relatively darker, the energy-saving lighting device uses a parabolic reflector in the lampshade body to condense light onto a cone reflector below, and a nonlinear reflector having multiple facets that are arranged subject to predetermined angles to form a light distribution curve to reflect light onto a predetermined illumination block and to let some light rays to be secondarily refracted onto the predetermined illumination block, achieving accurate lighting control and even distribution of light in the predetermined illumination block.

### BRIEF DESCRIPTION OF THE DRAWINGS

FIG. 1A is a schematic drawing of an open type lampshade according to the prior art.

FIG. 1B is a schematic drawing of a full-closed lampshade according to the prior art.

FIG. 2 is a schematic sectional view of an energy-saving lighting device in accordance with the present invention.

FIG. 3 is an enlarged view of a part of the energy-saving lighting device in accordance with the present invention, illustrating the light-distribution curve of the nonlinear reflector.

FIG. 4 is a schematic drawing illustrating the light reflecting function of the parabolic reflector of the energy-saving lighting device in accordance with the present invention.

FIG. 5 is a schematic drawing illustrating the light reflecting function of the cone reflector of the energy-saving lighting device in accordance with the present invention.

FIG. 6 is a schematic drawing illustrating the light reflecting function of the nonlinear reflector of the energy-saving lighting device in accordance with the present invention.

FIG. 7 is a schematic drawing illustrating the light path of the direct light rays from the light emitting device of the energy-saving lighting device in accordance with the present invention.

FIG. 8 is a schematic drawing illustrating the light path of the primarily refracted light rays in accordance with the present invention.

FIG. 9 is a schematic drawing illustrating the measurement of the luminance of the direct light rays and the primarily refracted light rays in accordance with the present invention (I).

FIG. 10 is a schematic drawing illustrating the measurement of the luminance of the direct light rays and the primarily refracted light rays in accordance with the present invention (II).

FIG. 11 is a luminance distribution curve of the direct light rays and the primarily refracted light rays in accordance with the present invention.

FIG. 12 is a schematic drawing illustrating the measurement of the luminance of the secondarily refracted light rays in accordance with the present invention.

FIG. 13 is a luminance distribution curve of the secondarily refracted light rays in accordance with the present invention.

FIG. 14 illustrates the calculation of the light distribution curve of a circular surface illuminated by the nonlinear reflector in accordance with the present invention.

FIG. 15 is a schematic drawing illustrating the arrangement of refractive facet units in accordance with the present invention.

FIG. 16 is a schematic drawing illustrating circularly linked illuminated surface according to the present invention.

FIG. 17 is a schematic drawing illustrating linking of the centers of refractive facet units according to the present invention.

FIG. 18 is a schematic drawing illustrating a rectangular illuminated surface according to the present invention.

FIG. 19 is a schematic drawing illustrating an eccentric rectangular illuminated surface according to the present invention.

FIG. 20 is a schematic drawing illustrating projection of light out of a rectangular lampshade body according to the present invention.

FIG. 21 is a schematic drawing illustrating projection of light out of a trapezoidal lampshade body according to the present invention.

FIG. 22 is a schematic drawing illustrating the arrangement of the nonlinear reflector in one corner of the illuminated surface according to the present invention.

FIG. 23 is a schematic drawing illustrating linking of facets of a rectangular loop-like nonlinear reflector.

FIGS. 24 and 24A are a flow chart illustrating the calculation of the light distribution curve of the nonlinear reflector in accordance with the present invention.

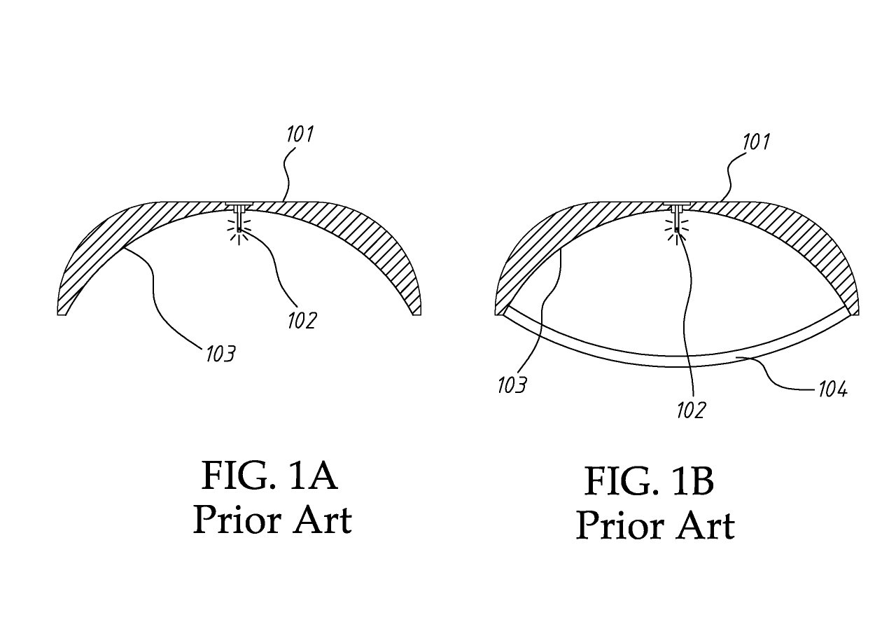

### DETAILED DESCRIPTION OF THE PREFERRED EMBODIMENT

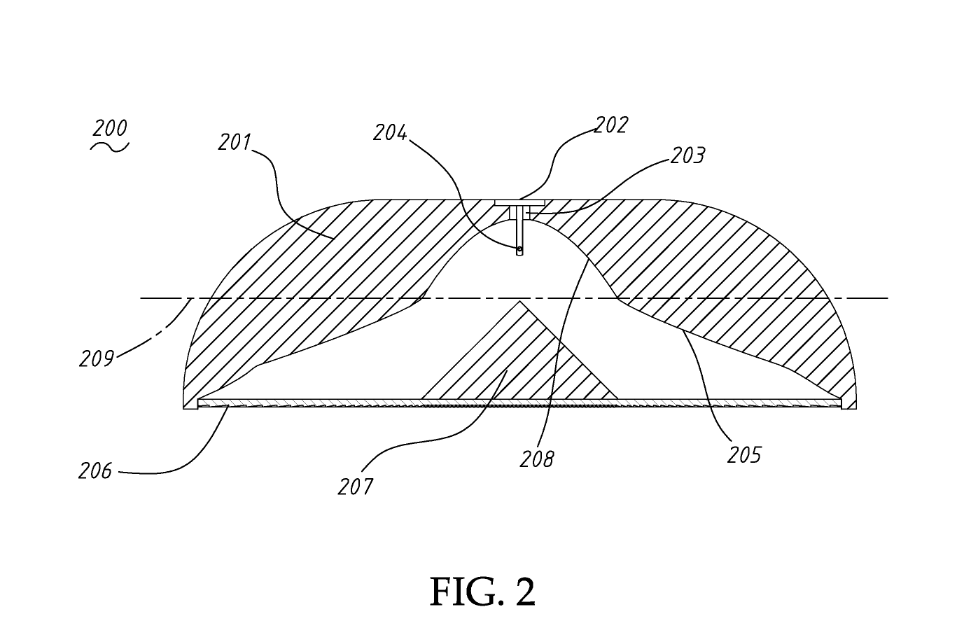

Referring to FIG. 2, an energy-saving lighting device 200 in accordance with the present invention is shown comprising a lampshade body 201. The lampshade body 201 comprises a top through hole 202 in which a lamp holder 203 is installed to hold a light emitting device 204 that emits light when electrically connected.

The lampshade body 201 comprises a parabolic reflector 208 formed of an upper part thereof above the imaginary line, referenced by 209. The parabolic reflector 208 has a through hole for the passing of the light emitting device 204.

The lampshade body 201 comprises a nonlinear reflector 205 formed of a lower part thereof below the imaginary line, referenced by 209. The nonlinear reflector 205 is disposed inside the lampshade body 201 and abutted to the parabolic reflector 208.

Further, a light-transmissive plate 206 is detachably covered on the bottom side of the lampshade body 201 within the illumination area. A reflector cone 207 is fixedly mounted on the inner side of the light-transmissive plate 206 within the lampshade body 201 in such a position that the vertex of the reflector cone 207 is aimed at the light emitting device 204 and, the parabolic reflector 208 reflects the emitted light from the light emitting device 204 onto the reflector cone 207 for enabling the reflector cone 207 to reflect the condensed light onto the nonlinear reflector 205 that reflects the refracted light from the reflector cone 207 toward the illumination area to achieve the desired light distribution.

The nonlinear reflector 205 is formed of multiple facets, and the size and angle of each facet of the nonlinear reflector 205 are calculated subject to the principle of optical reflection and expected contained angle between the incident light and the light reflected by each facet toward a specific illumination block.

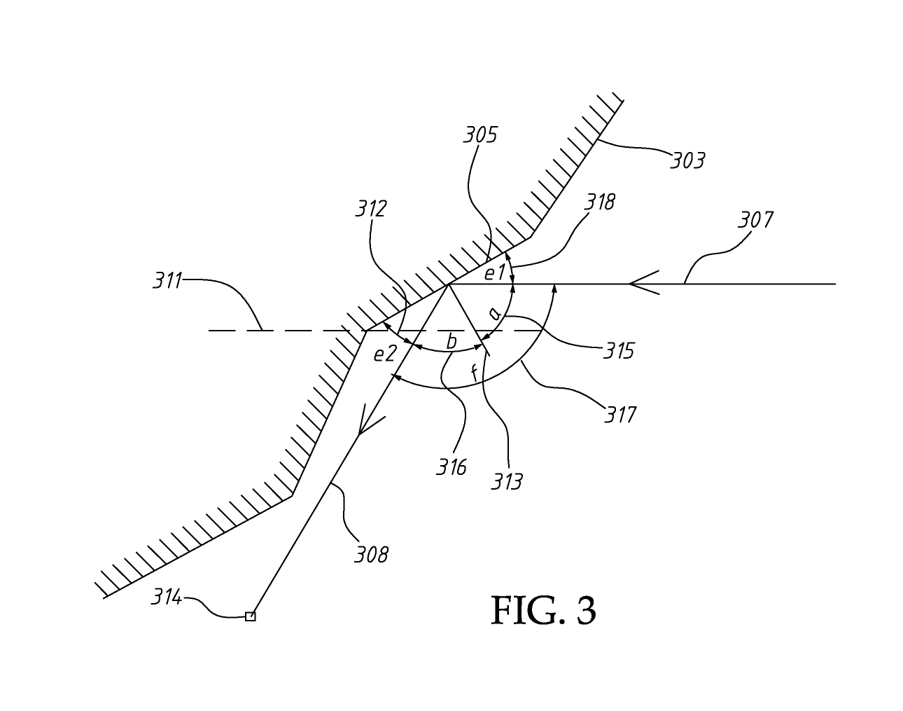

FIG. 3 is an enlarged view of part 303 of the nonlinear reflector 205. When an incident light 307 in a predetermined direction falls on one facet 305 and is being reflected by the facet 305 onto a predetermined illumination block 314, the incident light 307 and the reflected light 308 define a contained angle (f) 317. According to the principle of reflection, we can obtain that: contained angle f (317)÷2=incident angle a (315)=reflective angle b (316), and thus the accurate angle of the normal line 313 is obtained. Because the normal line 313 is perpendicular to the facet 305, the angle (e2) 312 relative to the horizontal line 311 can thus be obtained.

Simply speaking, the incident light 307 is kept in a parallel relationship relative to the horizontal line 311 and the contained angle e1 (318) defined between the facet 305 and the incident light 307 is equal to the angle (e2) 312; the angle e1 (318)=90-degrees angle-incident angle a (315)=90°−f(317)/2.

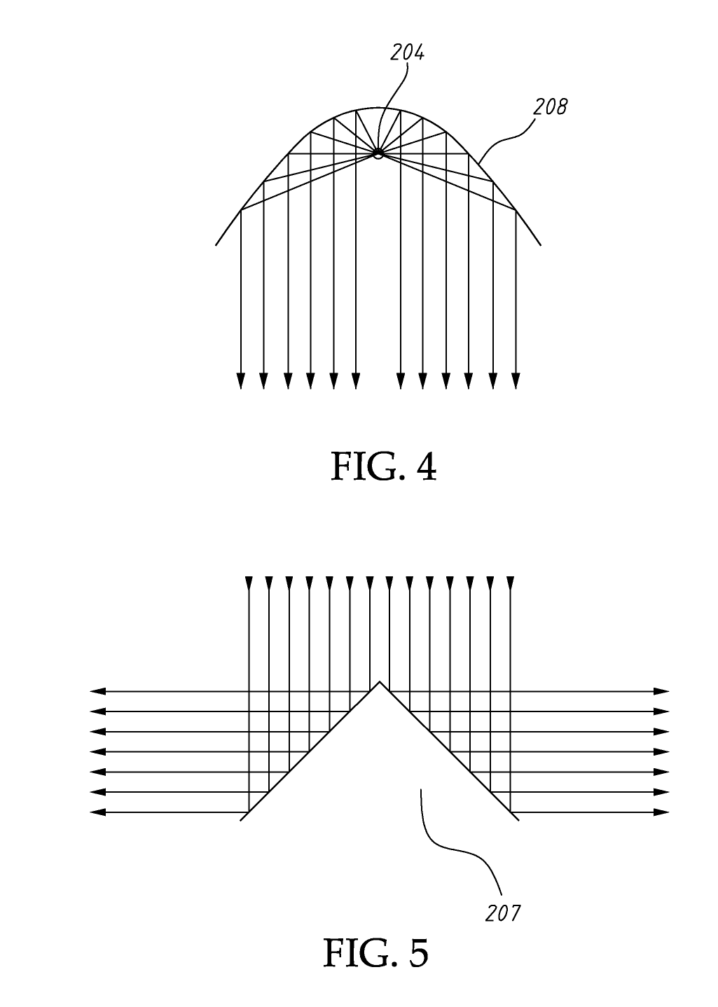

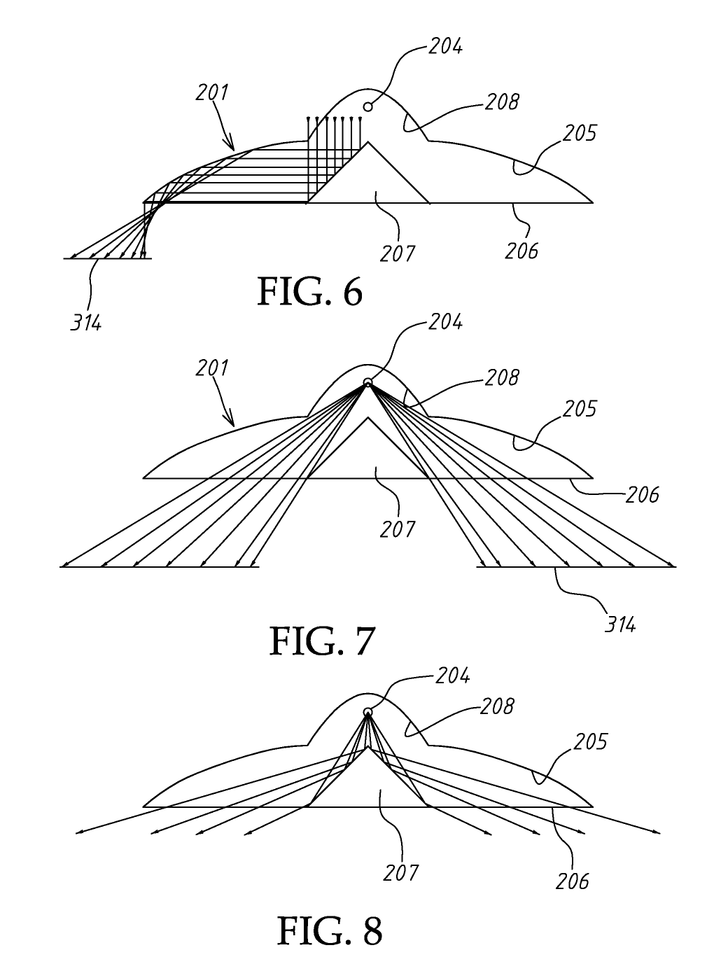

Referring to FIG. 4, the light emitting device 204 is disposed at the focus of the parabola of the parabolic reflector 208 so that the parabolic reflector 208 converts incident light rays into downwardly extending parallel light rays. Referring to FIG. 5, the downwardly extending parallel light rays reflected by the parabolic reflector 208 are then converted into horizontally extending parallel light rays by the reflector cone 207. Referring to FIG. 6, horizontal incident light rays that fall upon the inner light-distribution curve of the nonlinear reflector 205 are reflected by the nonlinear reflector 205 toward the predetermined illumination block 314.

Referring to FIGS. 7 and 8, due to the factors that the direct light rays that are emitted by the light emitting device 204 and directly fall upon the predetermined illumination block 314 (see FIG. 7) and the light rays that emitted by the light emitting device 204 toward the cone reflector 207 and first time refracted by the cone reflector 207 onto the predetermined illumination block 314 (see FIG. 8) do not go through the parabolic reflector 208 or the reflector cone 207, the distances between each light-receiving point of the predetermined illumination block 314 and the light emitting device 204 are unequal and illuminance is inversely proportional to the square of projection, it is difficult to disclose the function of this curve by a linear equation. Therefore, the invention divides this curve into multiple segments and employs a computer program to calculate the refractive angle of each of the segments subject to illumination requirement for every individual zone in this predetermined illumination block 314.

The calculation flow is described hereinafter.

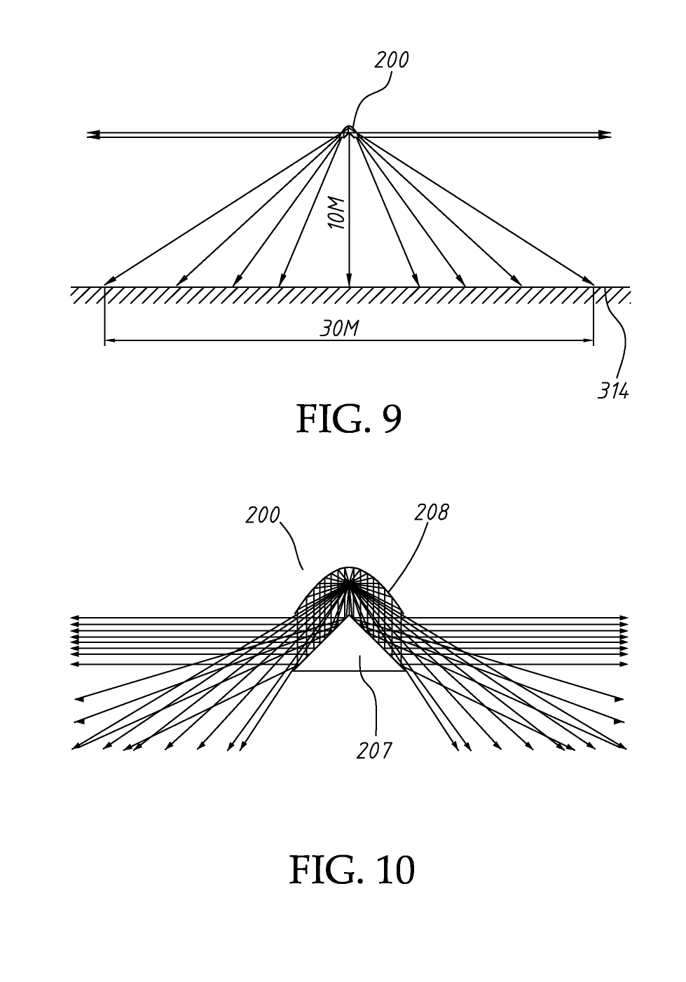

At first, measure the luminance distribution of the direct light rays and the primarily refracted light rays. As shown in FIGS. 9 and 10, before installation of the nonlinear reflector 205 in the energy-saving lighting device 200, the light rays are refracted secondarily by the parabolic reflector 208 and the cone reflector 207 are diffused in different directions beyond the predetermined illumination block 314. As the direct light rays and the primarily refracted light rays affect light distribution in further calculation, the luminance at every light-receiving point in the predetermined illumination block 314 must be measured and recorded at this time.

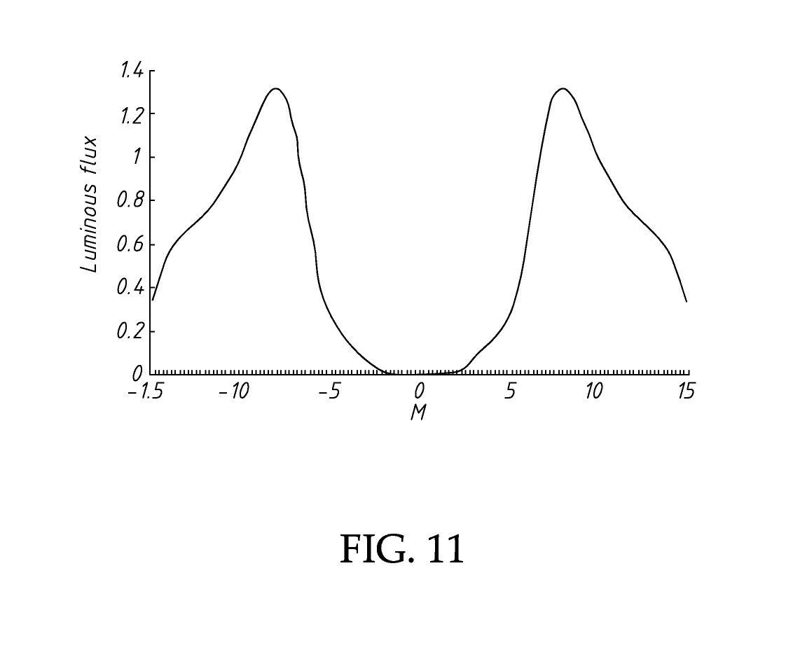

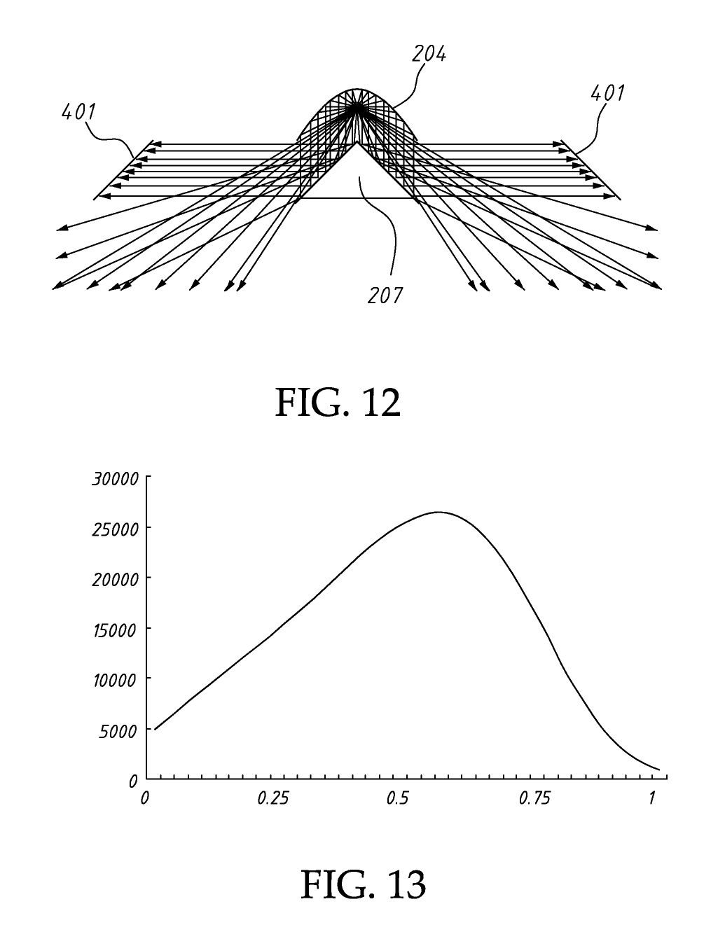

Referring to FIG. 11, in this example, the area of the predetermined illumination block 314 is 10M×30M; the distance between the light emitting device 204 and the floor is 10M; the focus of the parabola of the parabolic reflector 208 is 25 mm; the opening of the parabola of the parabolic reflector 208 is 166 mm. To facilitate computation, this curve is converted into a unitary real parameter function close to the curve. This function is named hereinafter as DIRECT(x).

After computation through an optical simulation software, the luminous flux of the direct light rays and the primarily refracted light rays is about 16.5% of the light source. This luminous flux is named hereinafter as LM1.

Thereafter, measure the luminance distribution of the secondarily refracted light rays. At this time, a luminance metering plate 401 is used to measure the intensity of the secondarily refracted light rays. The more the number of points been measured the higher the precision of measurement will be. FIG. 13 illustrates the secondary refraction luminance distribution curve. To facilitate computation, this curve is converted into a unitary real parameter function close to the curve. This function is named hereinafter as INDIRECT(x). In the example shown in FIG. 9, the luminous flux of the secondarily refracted light rays after computation through an optical simulation software is about 72% of the light source. This luminous flux is named hereinafter as LM2.

In this example, the total luminous flux of the direct light rays, primarily refracted light rays and secondarily refracted light rays is 88.5%. This total luminous flux does not reach 100% just because the refractive index of the refractive surface is 97% and, the light source in the simulation is not an ideal spot light source. Most light loss occurs in the functioning of the parabolic reflector 208 to reflect a part of the light rays back onto the light emitting device 204. The light rays that are reflected back onto the light emitting device 204 are ineffective light rays. Actually, the use of a frosted or sanded glass to avoid dazzling in a conventional lighting fixture causes a light energy loss greater than the computation of the present invention.

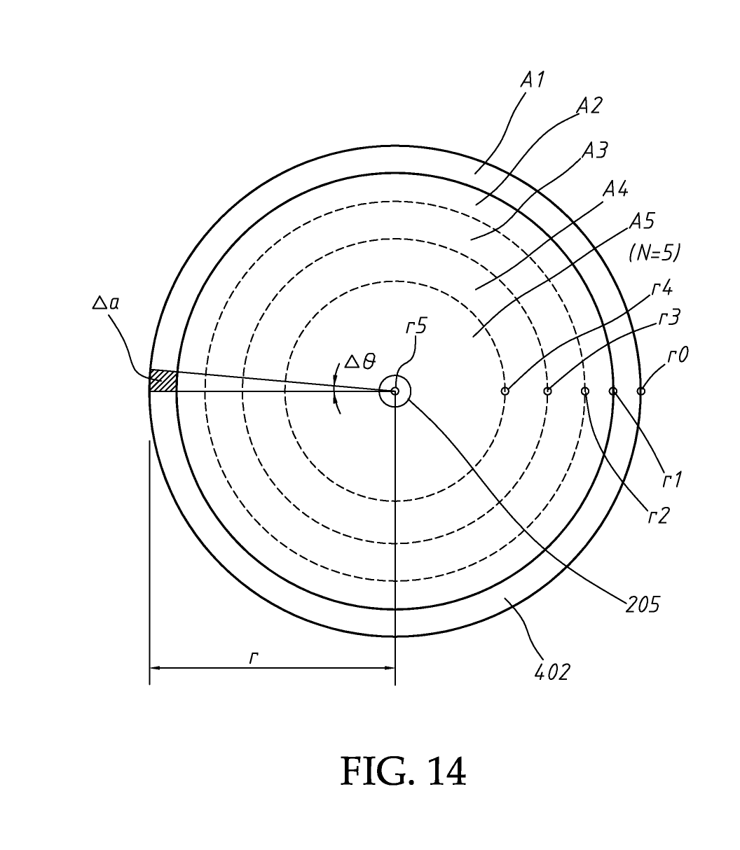

Thereafter, calculate the light distribution curve of the circular surface 402 illuminated by the nonlinear reflector 205. As illustrated in FIG. 14, if the predetermined illumination block 314 is a circular illuminated surface 402, the computation is made subject to the following steps:
1. Equally divide the area of the circular illuminated surface 402 into multiple blocks, for example, five blocks A1, A2, A3, A4 and A5, in which A1=A2=A3=A4=A5. The number of the divided blocks is the higher the average luminance will be. In this example, the circular illuminated surface is divided into 5 blocks. In actual practice, it can be divided into several tends of thousands blocks or even several million blocks. As the operating speed of an existing advanced computer is very fast, execution through a computer software program does not requires much execution time. For easy explanation, the number of the divided blocks is named as N.
2. Divide the circumference equally into multiple parts, for example, 100 parts, as shown in FIG. 14, in which each part defines a contained angle Δθ=3.6°. In actual practice, the circumference can be equally divided into several tends of thousands parts or even several million parts.
3. Divide the luminous flux of the secondarily refracted light rays into N parts. After deduction of the integral DIRECT (N block) from the N parts, the luminous flux of the secondarily refracted light rays to be distributed onto the block is obtained as LMS. Thus, the following formula 1 is obtained:

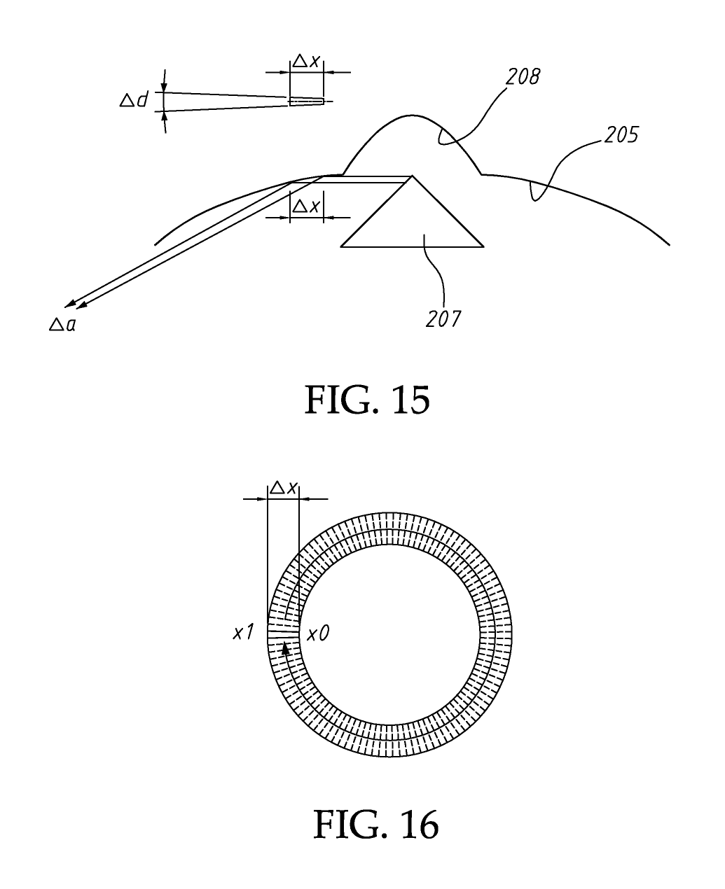

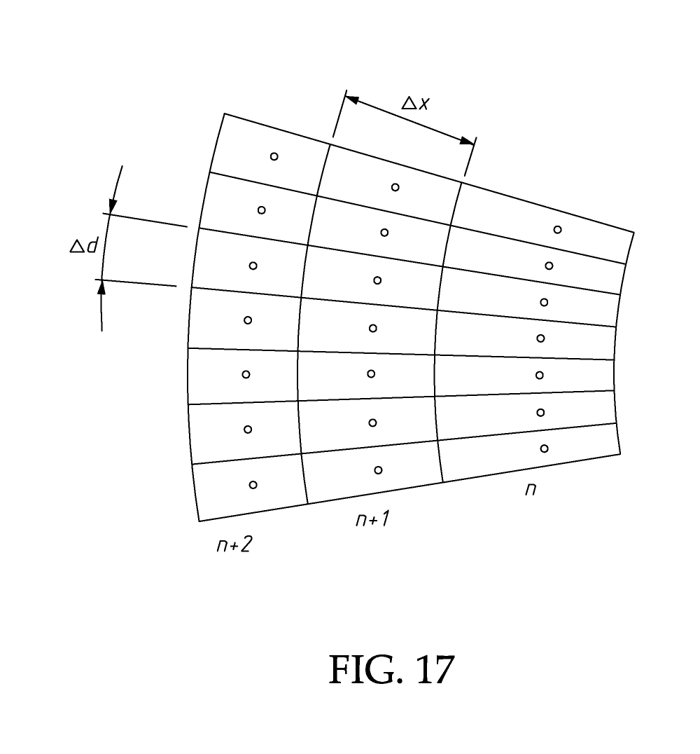

LMS[N]=LM2/N−LM1[N] 1

[remarks: in formula 1, LM1[N] is the total luminous flux of the direct light rays and the primarily refracted light rays in the N^{th} block that is calculated after putting in the integral function of DIRECT (N^{th} block)].
4. As the intensity of the secondarily refracted light rays is not constant, as shown in FIG. 15, a length Δy extending from the vertex of the cone reflector 207 is calculated with the integral INDIRECT(x) to let the luminance of the refracted light falling upon A[N] be equal to LMS[N].
5. In FIG. 16, the refractive facet unit enables the secondarily refracted light to fall upon Δa in FIG. 14. As Δθ of the circular illuminated surface is equal to Δd of the refractive facet unit, it is easily understandable when compared to the rectangular illuminated surface to be outlined later.
6. Link all the refractive facet units to form the secondarily refracted surface A[N].
7. Repeat steps 4˜6 till N^{th}, finishing the light distribution curve of the light refracted by the nonlinear reflector onto the circular illuminated surface.
8. Minor overlapping or leakage may occur during linking of all the refractive facet units. In actual experimentation, the values approaching zero are taken for Δd and Δy. Simply picking up the centers of all the refractive facet units shown in FIG. 17 for linking by means of digital filters (IIR, FIR, Bézier), a similar nonlinear distribution curve of luminous intensity can be obtained.

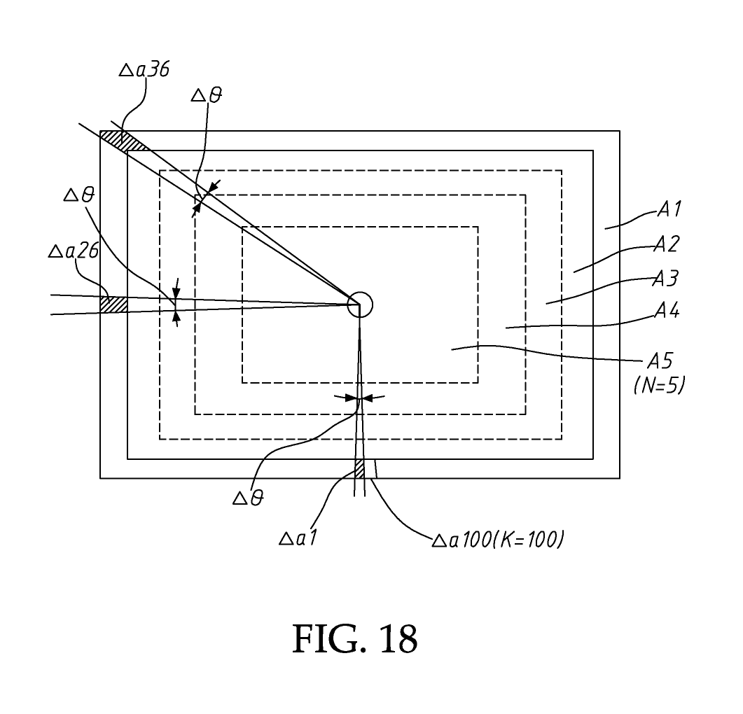

As conventional lighting system adopts a rectangular array arrangement concept, the use of a circular nonlinear reflector may cause occurrence of an overlapped luminous zone or a dark zone. Thus, a rectangular illuminated surface 403 is required. If the predetermined illumination block 314 is a rectangular illuminated surface 403, as shown in FIG. 18, the computation of the light distribution curve of the rectangular surface 403 illuminated by the nonlinear reflector 205 is done subject to the following steps:
1. Equally divide the area of the rectangular illuminated surface 403 into multiple blocks, for example, five blocks A1, A2, A3, A4 and A5, in which A1=A2=A3=A4=A5.
2. Divide the rectangle equally into multiple parts, for example, 100 parts (k parts), as shown in FIG. 18, in which each part defines a contained angle Δθ=3.6°.
3. Divide the luminous flux of the secondarily refracted light rays into N parts. After deduction of the integral DIRECT (N block) from the N parts, the luminous flux of the secondarily refracted light rays to be distributed onto the block is obtained as LMS.
4. As the intensity of the secondarily refracted light rays is not constant, as shown in FIG. 18, a length Δy extending from the vertex of the cone reflector 207 is calculated with the integral INDIRECT(Δy) to let the luminance of the refracted light falling upon A[N] be equal to LMS[N].
5. Referring also to the explanation of the example of the circular illuminated surface shown in FIG. 15, Δa of the rectangular illuminated surface is not all equal. As illustrated in FIG. 18, the surface areas of Δa1, Δa26, Δ36, etc., are unequal. To achieve even distribution of light, Δd must be relatively adjusted subject to Δa as follows:

Δd[k]=360° ·Δa[k]/A[N] 2

[remark: k in formula 2 is the number of parts divided from the rectangle]
6. Link all the refractive facet units to form the secondarily refracted surface a[N]. Unlike the circular illuminated surface, Δd of the rectangular illuminated surface is not a constant value.
7. Repeat steps 4˜6 till N^{th}, finishing the light distribution curve of the light refracted by the nonlinear reflector onto the rectangular illuminated surface.
8. Minor overlapping or leakage may occur during linking of all the refractive facet units. In actual experimentation, the values approaching zero are taken for Δd and Δy. Simply picking up the centers of all the refractive facet units shown in FIG. 17 for linking by means of digital filters (IIR, FIR, Bézier), a similar nonlinear distribution curve of luminous intensity can be obtained.

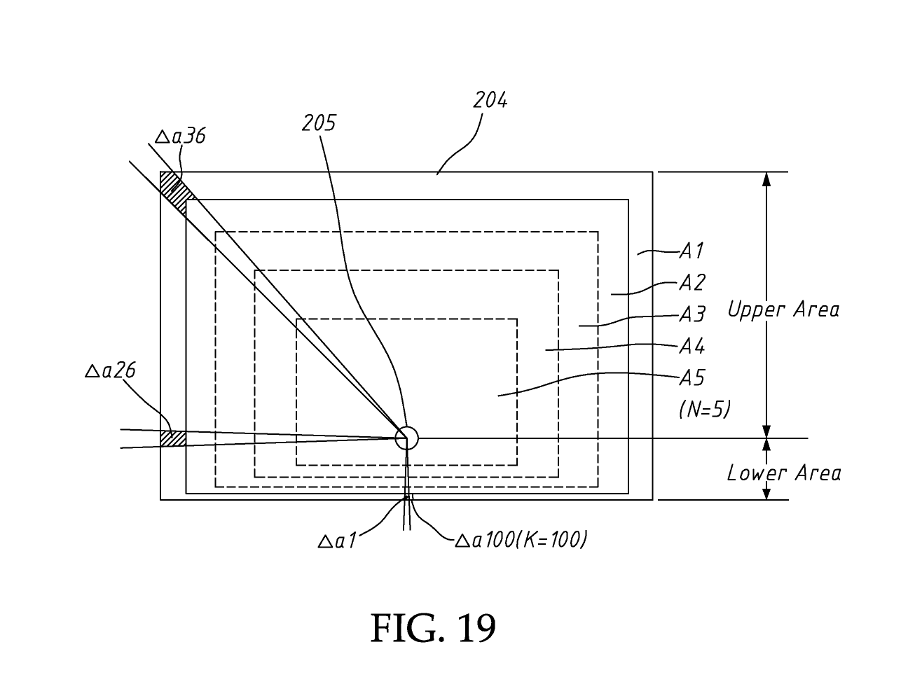

If the predetermined illumination block 314 is an eccentric rectangular illuminated surface 404, the computation of the light distribution curve of the eccentric rectangular illuminated surface 404 illuminated by the nonlinear reflector 205 is explained hereinafter. As shown in FIG. 19, the light source of a lighting device, such as table lamp or street light, may be not disposed at the center of the surface to be illuminated. The computation of a nonlinear reflector for this eccentric rectangular illuminated surface (light-receiving surface) 404 is similar to the computation of the light distribution curve of the rectangular surface 403 illuminated by the nonlinear reflector 205. To facilitate the fabrication of the nonlinear reflector, the ratio between the upper area and the lower area relative to the light source is better a constant value upon division of area a[k] (see FIG. 19). In this manner, linking of refractive facet units exhibits a better streamline.

The computation of the light distribution curve of the nonlinear reflector 205 where the light emitting device 204 is not within the range of the light-receiving surface is explained hereinafter.

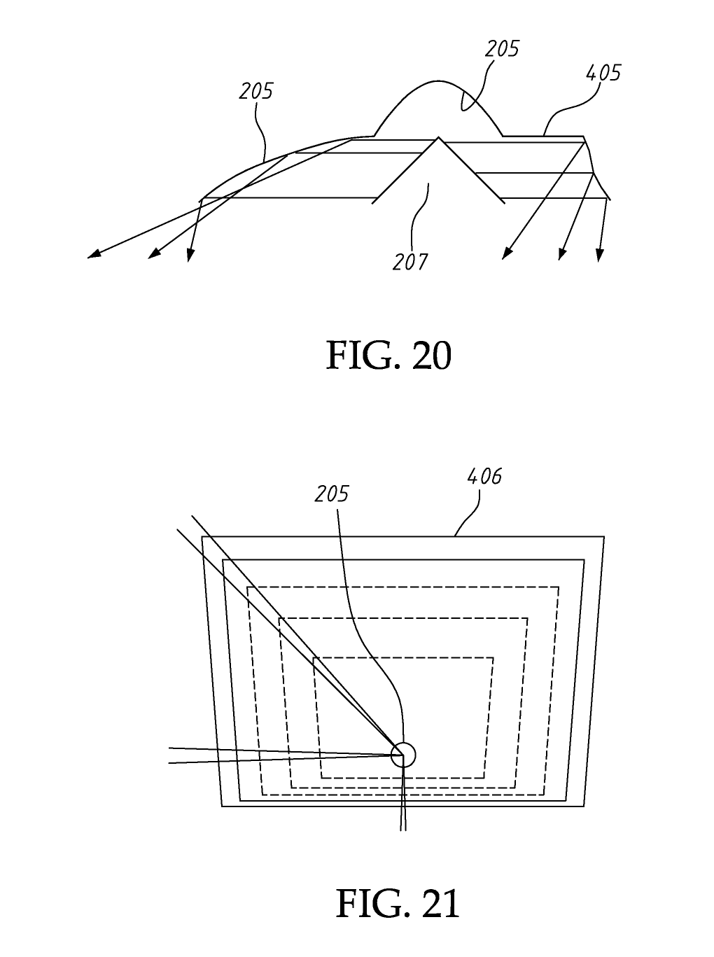

In some lighting devices, the light emitting device 204 may be not within the rectangular range (such as projection lamp). All the refractive facet units refract light rays toward one same side. In this case, an extension plate 405 is added, as shown in FIG. 20, enabling light rays to be projected leftwards.

The computation of the light distribution curve of the nonlinear reflector 205 for use in an energy-saving lighting device using a light emitting device 204 having an angle of elevation is explained hereinafter.

In some lighting devices (such as street light), the projecting angle of the light emitting device 204 may be not kept in a parallel relationship relative to the illuminated surface. Subject to the angle of elevation, it can be converted into a trapezoidal light-receiving surface 406, as shown in FIG. 21. The computation of the light distribution curve of the nonlinear reflector for use in this example is same as the computation of the aforesaid eccentric rectangular illuminated surface (light-receiving surface) 404.

The computation of the light distribution curve of the nonlinear reflector 205 for use in an energy-saving lighting device to be installed in a corner area is explained hereinafter.

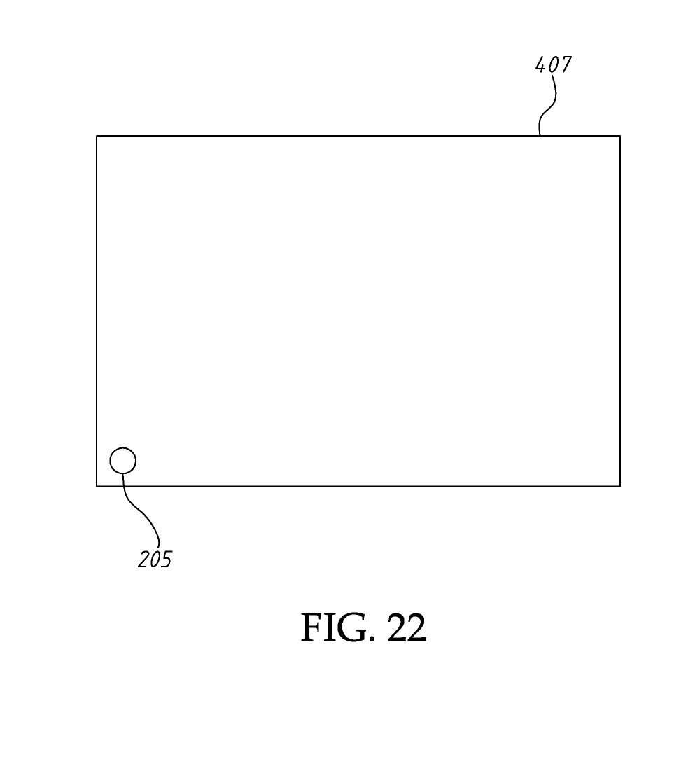

In some arrangement, the light emitting device 204 is installed in a corner area relative to the illuminated surface 407 (to minimize the number of street lamp posts, multiple light emitting devices may be installed in one single lamp post). In this case, as shown in FIG. 22, the nonlinear reflector is eccentric in horizontal as well as in vertical. The computation of the light distribution curve is to combine the computation of the light distribution curve of the nonlinear reflector for an eccentric rectangular illuminated surface, the computation of the light distribution curve of the nonlinear reflector where the light emitting device is not within the range of the light-receiving surface and the computation of the light distribution curve of the nonlinear reflector for use in an energy-saving lighting device using a light emitting device having an angle of elevation.

Endless linking subject to a predetermined shape design is explained hereinafter.

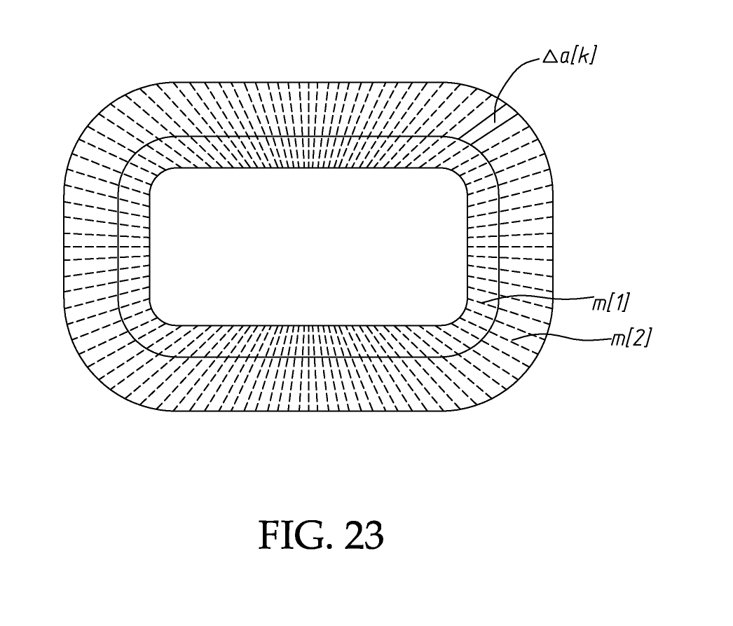

When making a lighting device, the nonlinear reflector 205 may be made in a rectangular, polygonal or elliptical shape to match with the surroundings or to satisfy certain considerations. The aforesaid circular linking arrangement may be modified into, for example, a rectangular linking arrangement as shown in FIG. 23. Calculation of different nonlinear reflectors does not need to consider the complicated calculation of the surface area of the refractive facet units. By means of equally divides the whole surface area and count the proportion of the surface area of the refractive face units, the calculation becomes easy.

s[k]=(m[N]/k)/Δa[k] 3

[remark: s[k] in formula 3 is the proportion of the surface area of the refractive face units after even division of the whole surface area]
[remark: m[N] is the whole surface area (for example, the are surrounded by the second frame line and the third frame line is m[2])].

The computation is same as the computation of the nonlinear reflector for rectangular illuminated surface. When calculating Δd[k], multiply by s[k].

Δd[k]=s[k]·360° ·Δa[k]/A[N] 4

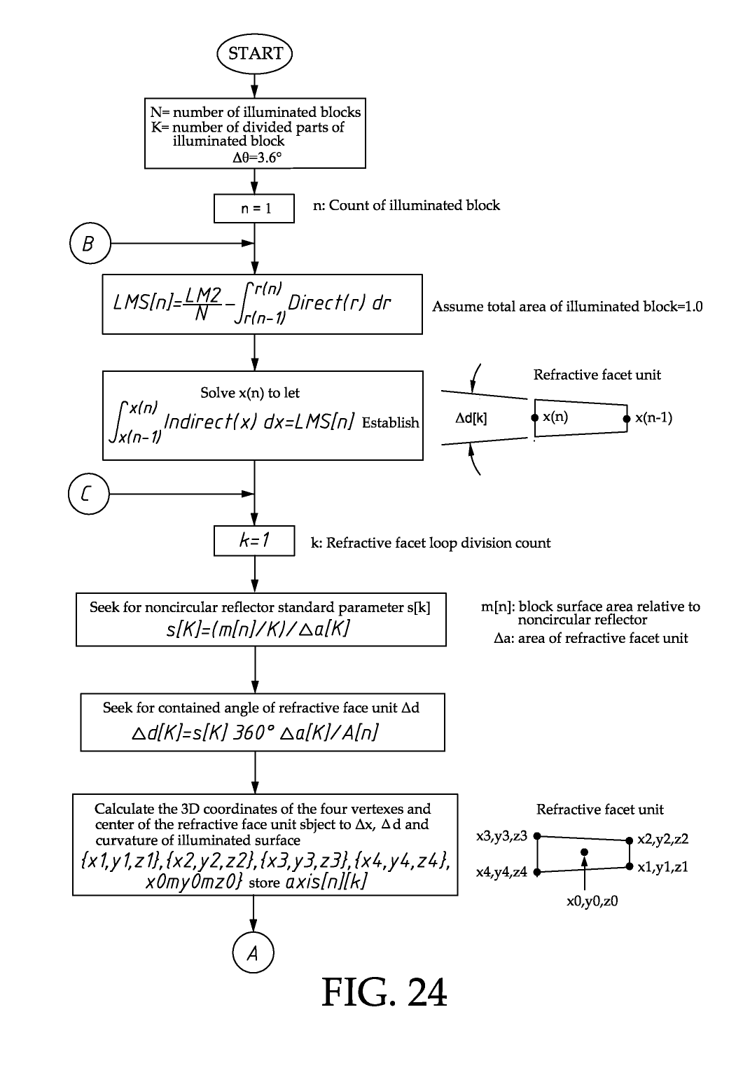

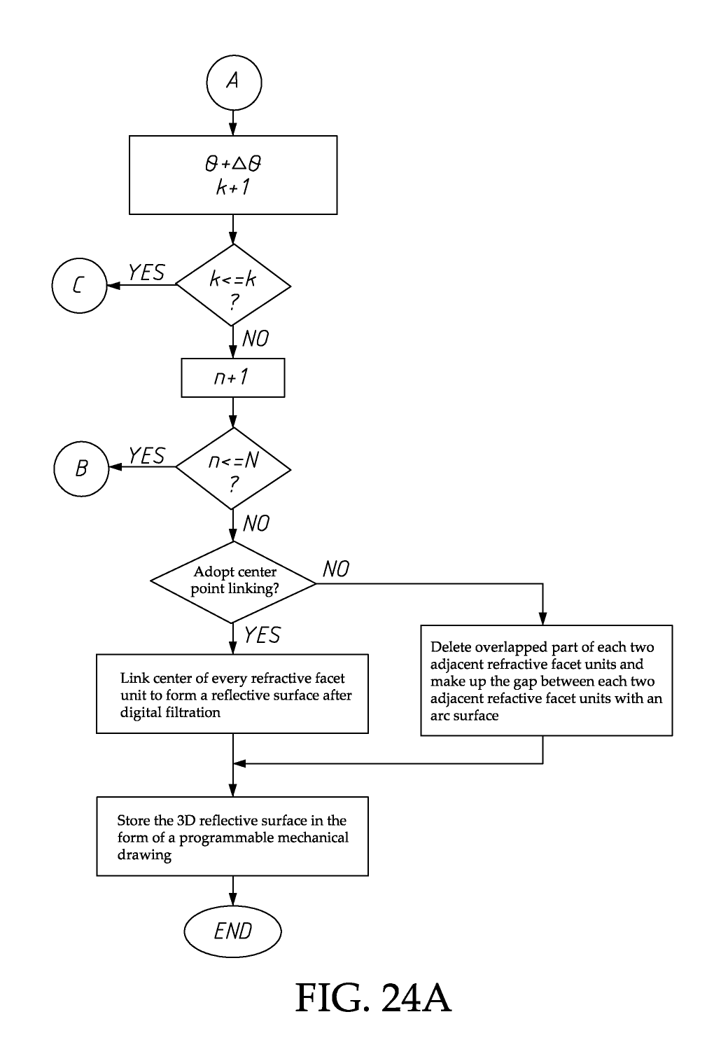

FIGS. 24 and 24A illustrate the flow of the computation of the light distribution curve of the nonlinear reflector 205. As illustrated, the invention employs a computer software program to divide the curve into several segments subject to illuminance requirement for each partition area in the predetermined illumination block 314 and to calculate the refractive angle of each segment of the curve, thereby obtaining the light distribution curve of the linkage of the facets of the nonlinear reflector 205.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An energy-saving lighting device, comprising:
a lampshade body, said lampshade body having installed therein a lamp holder electrically connected to power supply means;
a light emitting device installed in said lamp holder for emitting light;
a parabolic reflector adapted for converting a part of light rays emitted by said light emitting device into downwardly extending parallel light rays, said parabolic reflector having a through hole on a top side thereof for the passing of said light emitting device;
a light transmissive plate mounted in an illumination side of said lampshade body;
a cone reflector fixedly mounted on an inner side of said light-transmissive plate, said reflector cone having a vertex aimed at the center of said light emitting device and adapted for converting said downwardly extending parallel light rays into horizontally extending light rays; and
a nonlinear reflector fixedly mounted in said lampshade body and abutted against said parabolic reflector, said nonlinear reflector comprising a plurality of facets connected to one another at an inner side thereof and constituting a light distribution curve, the size and angle of each said facet being calculated subject to the principle of optical reflection and expected contained angle between the incident light of said horizontally extending parallel light rays and the light reflected by the respective facet toward a predetermined illumination block;
wherein the light emitted by said light emitting device partially directly projects onto said predetermined illumination block and partially reflected or refracted by said parabolic reflector, said cone reflector and said nonlinear reflector onto said predetermined illumination block; divide the predetermined illumination block to be illuminated equally into multiple sub blocks, and calculate the luminous flux of every said sub block of the direct light emitted by said light emitting device onto the respective sub block and the light emitted by said light emitting device and primarily refracted by said cone reflector onto the respective sub block; the light rays emitted by said light emitting devices and secondarily refracted by said parabolic reflector and said cone reflector toward the facets of said nonlinear reflector are reflected by the facets of said nonlinear reflector onto predetermined sub blocks of said predetermined illumination block to make even the luminous flux of every said sub block, achieving even distribution of light in said predetermined illumination block.

2. The energy-saving lighting device as claimed in claim 1, wherein said predetermined illumination block is a circular light-receiving surface.

3. The energy-saving lighting device as claimed in claim 1, wherein said predetermined illumination block is a rectangular light-receiving surface.

4. The energy-saving lighting device as claimed in claim 3, wherein said light emitting device is beyond the range of said rectangular light-receiving surface; the facets of said linear reflector refract incident light toward one same side; an extension plate is attached to an opposite side of said linear reflector to let light be projected toward one same side.

5. The energy-saving lighting device as claimed in claim 1, wherein said predetermined illumination block is an eccentric rectangular light-receiving surface.

6. The energy-saving lighting device as claimed in claim 5, wherein said light emitting device has an angle of elevation so that said predetermined illumination block is converted into a trapezoidal light-receiving surface.

7. The energy-saving lighting device as claimed in claim 1, wherein said light emitting device is arranged in a corner area relative to said predetermined illumination block in an eccentric manner in horizontal direction as well as vertical direction.

8. The energy-saving lighting device as claimed in claim 1, wherein said nonlinear reflector has a rectangular shape.

9. The energy-saving lighting device as claimed in claim 1, wherein said nonlinear reflector has a polygonal shape.

10. The energy-saving lighting device as claimed in claim 1, wherein said nonlinear reflector has an elliptical shape.
